(19) United States
(12) Patent Application Publication
(10) Pub. No.: US 2019/0171319 A1
(43) Pub. Date: Jun. 6, 2019

(54) DISPLAY DEVICE WITH BUILT-IN TOUCH SENSOR, AND DRIVE METHOD THEREOF

(71) Applicant: Sharp Kabushiki Kaisha, Osaka (JP)

(72) Inventors: Atsushi AOKI, Sakai City (JP); Daiji KITAGAWA, Sakai City (JP); Yousuke NAKAMURA, Sakai City (JP); Teruhisa MASUI, Sakai City (JP); Masashi MAYUMI, Sakai City (JP); Kunihiko YAMAMOTO, Sakai City (JP)

(21) Appl. No.: 16/185,029

(22) Filed: Nov. 9, 2018

(30) Foreign Application Priority Data
Dec. 1, 2017 (JP) 2017-231382

(51) Int. Cl. G06F 3/041; G06F 3/044

(52) U.S. Cl. CPC G06F 3/0412; G06F 3/044

(57) ABSTRACT

A display device, with a built-in touch sensor, including a display unit where sensor electrodes are provided, and a signal processing unit configured to process detection signals obtained from the sensor electrodes is provided with a segment-size switching unit configured to perform electrical connection and electrical disconnection of sensor electrodes such that a size of a segment serving as a unit of processing the detection signal becomes a size depending on an instruction signal. For example, the segment-size switching unit is configured by a switch circuit configured to switch a connection relationship between a plurality of sensor electrodes and a plurality of analog front ends, and a switching control unit configured to control operation of the switch circuit depending on the instruction signal.

### BACKGROUND OF THE INVENTION

### 1. Field of the Invention

The following disclosure relates to a display device with a built-in touch sensor and a drive method thereof, and more particularly, to a display device with a built-in touch sensor where a common electrode for image display is used also as a sensor electrode (touch detection electrode), and a drive method thereof.

### 2. Description of Related Art

A touch panel is attracting attention as an input device for performing operation at a computer system or the like. For example, in an electrostatic capacitance type touch panel, a position of a detection target object, such as a finger of a user (operator) or a touch pen, is detected based on a change in electrostatic capacitance. Such a touch panel is conventionally used by being superimposed on a display panel such as a liquid crystal panel. Such a touch panel which is superimposed on a display panel is referred to as an “out-cell touch panel”. For example, an out-cell touch panel has a sensor pattern as shown in FIG. 17 including two types of rhombus-shaped electrodes (electrodes 901 connected in a lateral direction and electrodes 902 connected in a longitudinal direction)

However, an out-cell touch panel has problems that weight and thickness of an entire device configured of a display panel and a touch panel are increased, and that power necessary to drive the touch panel is increased. Accordingly, in recent years, a display device having a configuration where a display panel and a touch panel are integrated is being developed. In such a display device, a part that functions as a touch sensor is provided inside the display panel. In the following, such a display device will be referred to as a “display device with a built-in touch sensor”.

Touch panels integrated with display panels are mainly those that are referred to as “on-cell touch panels” and those that are referred to as “in-cell touch panels”. Regarding an on-cell touch panel, a sensor electrode is provided between a polarization plate and one of two glass substrates forming a display panel. Regarding an in-cell touch panel, a sensor electrode is provided on an inside of two glass substrates.

While there are several types of touch panels as described above, the in-cell touch panels are becoming the mainstream in the market in recent years. The in-cell touch panels are expected to be used in various applications. For example, use in mobile phones (particularly, smartphones), tablet terminals, personal computers, amusement devices, in-vehicle devices, industrial appliances, and the like is expected.

For example, the in-cell touch panel has a sensor pattern as shown in FIG. 18 where a plurality of sensor electrodes 91 are arranged in a matrix on a glass substrate. Touch detection wires 92 are also disposed on the glass substrate. Each sensor electrode 91 is connected to a corresponding touch detection wire 92 by a contact portion 93. The touch detection wire 92 is connected to an IC including a circuit for performing a process of identifying a touch position based on a detection signal obtained from each sensor electrode 91. In such a configuration, the plurality of sensor electrodes 91 arranged on the glass substrate are used also as electrodes which are used to display an image (such as common electrodes of a liquid crystal display device). That is, one electrode is used as a sensor electrode for performing touch detection and as an electrode for image display. By using the electrode for image display and the sensor electrode in a shared manner, thinning and weight reduction of the device are realized.

In relation to the present case, Japanese Laid-Open Patent Publication No. 2016-51480 discloses a configuration where a plurality of sensor electrodes are electrically connected in an X-direction and a Y-direction so as to reduce a drive time for touch detection.

However, the in-cell touch panel currently does not achieve sufficient performance. One reason is that sensitivity is insufficient due to adopting in-cell. Sensor sensitivity of an electrostatic capacitance type touch panel is determined depending on a distance between a recognition target object, such as a finger or a pen, and a sensor (sensor electrode). More specifically, as the distance from the sensor to a recognition target object is increased, the sensor sensitivity is more reduced since a signal value of a detection signal is more reduced as shown in FIG. 19. Accordingly, since the distance from the sensor to a recognition target object (distance from the sensor to a contact surface) is increased due to adopting in-cell as can be seen in FIG. 20, the sensor sensitivity is reduced. As a result, reaction of the touch panel becomes slow. Thus, detection using a hovering function and detection of a glove or the like which are possible with the out-cell touch panel are difficult with the in-cell touch panel.

The following three reasons are conceivable as main reasons the sensitivity becomes insufficient due to adopting in-cell. A first reason is that the distance from the sensor to a recognition target object is increased due to adopting in-cell, as described above. A second reason is that the in-cell touch panel cannot adopt high-voltage driving because high-voltage driving greatly affects image display. A third reason is that driving for image display and driving for touch detection have to be performed in a time-divided manner so that the display device and the touch panel do not interfere with each other in the in-cell touch panel, and it is becoming difficult to secure a sufficient time period for touch detection as resolution of the display device is increased.

As described above, the in-cell touch panel cannot achieve sufficient performance due to insufficient sensitivity. Accordingly, there is a strong demand to increase the performance. Particularly, there is a strong demand to increase the performance with respect to a touch panel (in-cell touch panel) which is to be used in an in-vehicle device, an industrial appliance or the like demanding special user specifications. The invention disclosed in Japanese Laid-Open Patent Publication No. 2016-51480 is able to reduce a drive time for touch detection and to reduce power consumption, but is insufficient in terms of sensitivity.

### SUMMARY OF THE INVENTION

Accordingly, realization of a display device, with a built-in touch sensor, which has higher performance than the conventional one is desired.

A display device according to some embodiments is a display device, with a built-in touch sensor, including a display unit where K sensor electrodes for touch detection are arranged in a matrix, where K is an integer of four or more, and a signal processing unit configured to process detection signals obtained from the K sensor electrodes, the display device including:

a segment-size switching unit configured to perform electrical connection and electrical disconnection of sensor electrodes such that a size of a segment made up of one or J sensor electrodes becomes a size depending on an instruction signal, where J is an integer of 2 or more and K or less, the segment serving as a unit of processing the detection signals; and

a position detection processing unit configured to identify a touch position based on an output from the signal processing unit.

According to such a configuration, in a display device with a built-in touch sensor, the size of the segment, which is a unit of processing the detection signal, can be changed. Because a signal value of the detection signal is increased (i.e., sensitivity is increased) as the segment size is increased, a weak detection signal which was conventionally not detected can be detected by increasing the segment size as necessary. Accordingly, a display device with a built-in touch sensor which has higher performance than the conventional one is realized.

These and other objects, features, modes, and advantageous effects of the present invention will be made further apparent from the appended drawings and the detailed description of the present invention given below.

### BRIEF DESCRIPTION OF THE DRAWINGS

FIG. 1 is a diagram for describing a segment-size switching unit according to an embodiment of the present invention.

FIG. 2 is a block diagram for describing a functional configuration of a liquid crystal display device with a built-in touch sensor according to the embodiment.

FIG. 3 is a diagram for describing an example of a physical configuration according to the embodiment.

FIG. 4 is a circuit diagram showing a configuration of a pixel formation portion according to the embodiment.

FIG. 5 is a diagram for describing a sensor pattern constituting a touch panel according to the embodiment.

FIG. 6 is a diagram for describing a segment size according to the embodiment.

FIG. 7 is a diagram showing a schematic configuration of an IC according to the embodiment.

FIG. 8 is a diagram showing a connection state between touch detection wires and AFEs at a certain time point in a case in which a state of a segment is a first pattern according to the embodiment.

FIG. 9 is a diagram showing a connection state between touch detection wires and AFEs at a certain time point in a case in which a state of a segment is a second pattern according to the embodiment.

FIG. 10 is a diagram showing a connection state between touch detection wires and AFEs at a certain time point in a case in which a state of a segment is a third pattern according to the embodiment.

FIG. 11 is a diagram for describing providing a demultiplexer in a switch circuit according to the embodiment.

FIG. 12 is a diagram for describing providing a multiplexer in the switch circuit according to the embodiment.

FIG. 13 is a diagram for describing example of realization of an antenna sensor function according to the embodiment.

FIG. 14 is a diagram for describing example of realization of the antenna sensor function according to the embodiment.

FIG. 15 is a diagram for describing an advantageous effect achieved by realization of the antenna sensor function according to the embodiment.

FIG. 16 is a graph showing a relationship between a segment size and amplitude of a signal value of a detection signal according to the embodiment.

FIG. 17 is a diagram showing an example of a sensor pattern of an out-cell touch panel.

FIG. 18 is a diagram showing an example of a sensor pattern of an in-cell touch panel.

FIG. 19 is a graph showing a relationship between a distance from a sensor to a recognition target object and amplitude of a signal value.

FIG. 20 is a diagram for describing reduction in sensor sensitivity caused by adopting in-cell.

### DETAILED DESCRIPTION OF PREFERRED EMBODIMENTS

Hereinafter, an embodiment of the present invention will be described with reference to the drawings.

### 1. Functional Configuration

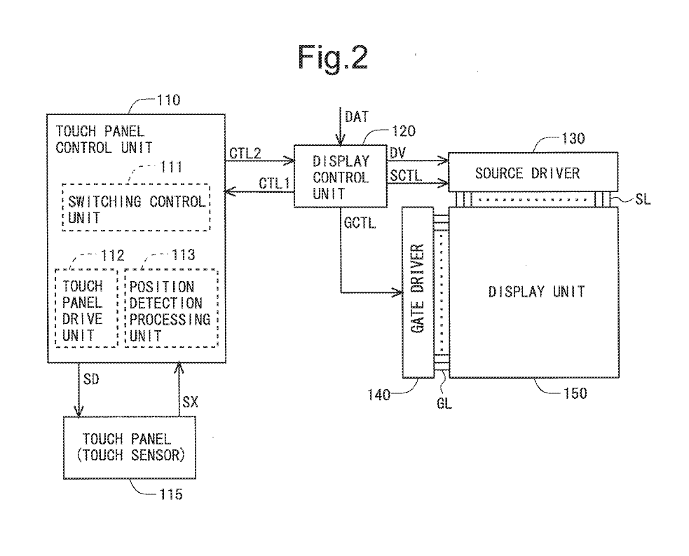

FIG. 2 is a block diagram for describing a functional configuration of a liquid crystal display device with a built-in touch sensor according to an embodiment of the present invention. The liquid crystal display device includes a touch panel control unit 110, a touch panel (touch sensor) 115, a display control unit 120, a source driver 130, a gate driver 140, and a display unit 150. The touch panel control unit 110 and the touch panel 115 are constituent elements related to touch detection, and the display control unit 120, the source driver 130, the gate driver 140, and the display unit 150 are constituent elements related to image display. It should be noted that since FIG. 2 is a diagram showing a functional configuration, a positional relationship between constituent elements are different from actual one.

The touch panel control unit 110 includes a switching control unit 111, a touch panel drive unit 112, and a position detection processing unit 113. The touch panel control unit 110 controls operation of the touch panel 115. At this time, the touch panel drive unit 112 supplies a drive signal SD for performing touch detection to the touch panel 115 based on a control signal CTL1 supplied from the display control unit 120. It should be noted that the control signal CTL1 is a signal for causing a process for touch detection to be performed in a period when a process for image display is not being performed (i.e., a signal for controlling a timing). When a detection signal SX as a detection result is supplied from the touch panel 115 to the touch panel control unit 110, a position where a touch was performed on the touch panel 115 is detected by the position detection processing unit 113 based on the detection signal SX. Then, the touch panel control unit 110 supplies a control signal CTL2 to the display control unit 120 such that a process depending on a position where the touch was performed is performed. It should be noted that, in the present embodiment, a size of a segment, which is a unit of processing the detection signal SX, can be switched (changed) as described later, and the switching control unit 111 controls switching of the segment size.

The touch panel 115 detects a touch of a recognition target object such as a finger or a glove (more specifically, contact or approach of a recognition target object). A detection timing is determined based on a drive signal SD which is supplied from the touch panel control unit 110. The touch panel 115 supplies a detection signal SX, as a detection result, to the touch panel control unit 110.

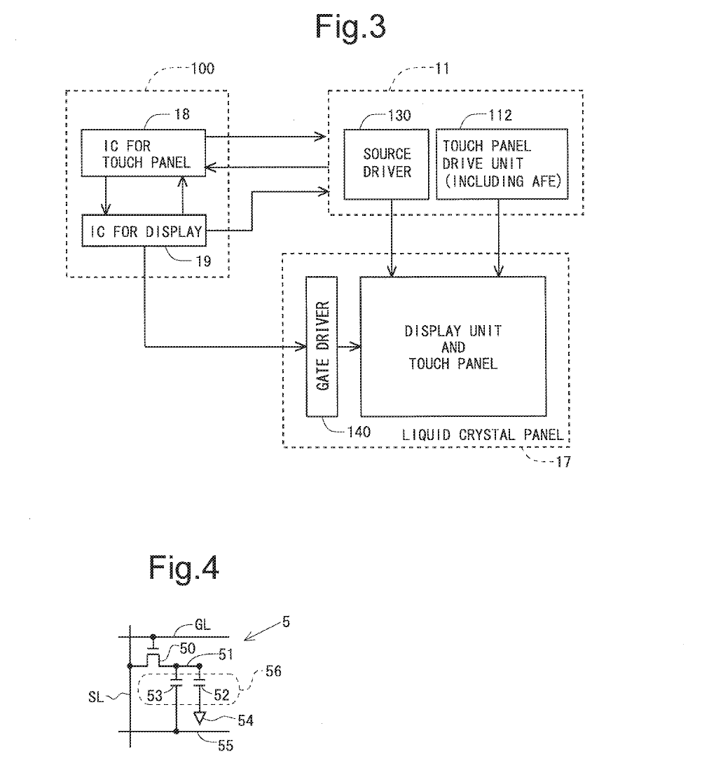

For example, physically, an IC 11 having a function of the source driver 130 and a function of the touch panel drive unit 112, an IC 18 for the touch panel, and an IC 19 for display are provided, as shown in FIG. 3, as ICs related to the constituent elements shown in FIG. 2. For example, the IC 18 for the touch panel has a function as the switching control unit 111, and a function as the position detection processing unit 113. For example, the IC 19 for display has a function as the display control unit 120. A liquid crystal panel 17 includes a part that functions as a display unit and a touch panel, and a part that functions as the gate driver 140. The IC 11 is provided on a substrate (TFT array substrate described later) forming the liquid crystal panel 17. The IC 18 for the touch panel and the IC 19 for display are provided, across an FPC, for example, on a backside of a substrate surface where the IC 11 is provided. In the following, for the sake of convenience, the IC 18 for the touch panel and the IC 19 for display are collectively referred to as a “controller”. A reference sign 100 is added to the controller. It should be noted that the configuration of the ICs as described above is only an example, and the configuration is not restrictive.

The display unit 150 displays an image under control of the source driver 130 and the gate driver 140. A plurality of source bus lines (video signal lines) SL and a plurality of gate bus lines (scanning signal lines) GL are disposed in the display unit 150. A pixel formation portion forming a pixel is provided at each intersection of the plurality of source bus lines SL and the plurality of gate bus lines GL. That is, the display unit 150 includes a plurality of pixel formation portions. The plurality of pixel formation portions form a pixel matrix. FIG. 4 is a circuit diagram showing a configuration of the pixel formation portion 5. Each pixel formation portion 5 includes a TFT (pixel TFT) 50, which is a switching element whose gate terminal is connected to the gate bus line GL passing through the corresponding intersection and whose source terminal is connected to the source bus line SL passing through the intersection, a pixel electrode 51 connected to a drain terminal of the TFT 50, a common electrode 54 and an auxiliary capacitance electrode 55, which are provided in a shared manner for the plurality of pixel formation portions 5, a liquid crystal capacitance 52 formed by the pixel electrode 51 and the common electrode 54, and an auxiliary capacitance 53 formed by the pixel electrode 51 and the auxiliary capacitance electrode 55. A pixel capacitance 56 is formed by the liquid crystal capacitance 52 and the auxiliary capacitance 53.

As the TFT 50 in the display unit 150, a thin film transistor (oxide semiconductor TFT) which uses oxide semiconductor for a semiconductor layer may be adopted, for example. More specifically, a TFT whose channel layer is formed by In-Ga-Zn-O (indium-gallium-zinc-oxide) which is oxide semiconductor whose main components are indium (In), gallium (Ga), zinc (Zn) and oxygen (O) (hereinafter such a TFT will be referred to as “IGZO-TFT”) may be adopted as the TFT 50. The oxide semiconductor has high electron mobility, and thus, by using the oxide semiconductor TFT, such as the IGZO-TFT, the TFT 50 can be miniaturized, and there are advantages of higher definition and increased aperture ratio. Furthermore, because leakage current is reduced, there is an advantage of reduced power consumption. Moreover, a voltage holding ratio of the pixel can be increased. There are various variations with respect to the material of the semiconductor layer of the thin film transistor. In addition to the thin film transistor which uses oxide semiconductor for the semiconductor layer, a thin film transistor which uses amorphous silicon for the semiconductor layer (a-Si TFT), a thin film transistor which uses microcrystalline silicon for the semiconductor layer, a thin film transistor which uses low-temperature polysilicon for the semiconductor layer (LTPS-TFT), and the like may also be adopted.

The display control unit 120 receives image data DAT which is transmitted from outside and the control signal CTL2 which is transmitted from the touch panel control unit 110, and outputs a digital video signal DV, a source control signal SCTL for controlling operation of the source driver 130, and a gate control signal GCTL for controlling operation of the gate driver 140. For example, the source control signal SCTL includes a source start pulse signal, a source clock signal, a latch strobe signal, and the like. The gate control signal GCTL includes a gate start pulse signal, a gate clock signal, and the like.

The source driver 130 applies a drive video signal to each source bus line SL based on the digital video signal DV and the source control signal SCTL which are transmitted from the display control unit 120. At this time, the digital video signal DV indicating a voltage to be applied to each source bus line SL is sequentially held at the source driver 130, at a timing of occurrence of a pulse of the source clock signal. Then, the held digital video signals DV are converted into analog voltages at a timing of occurrence of a pulse of the latch strobe signal. The analog voltages obtained by the conversion are simultaneously applied to all the source bus lines SL as the drive video signals.

The gate driver 140 repeats application of an active scanning signal to each gate bus line GL in a cycle of one vertical scan period, based on the gate control signal GCTL transmitted from the display control unit 120.

In this manner, an image based on the image data DAT transmitted from outside is displayed on the display unit 150 by application of the drive video signals to the source bus lines SL and application of the scanning signals to the gate bus lines GL. Further, when a touch on the touch panel 115 is detected, a process depending on the touch position is performed at the liquid crystal display device.

### 2. Configuration for Touch Detection

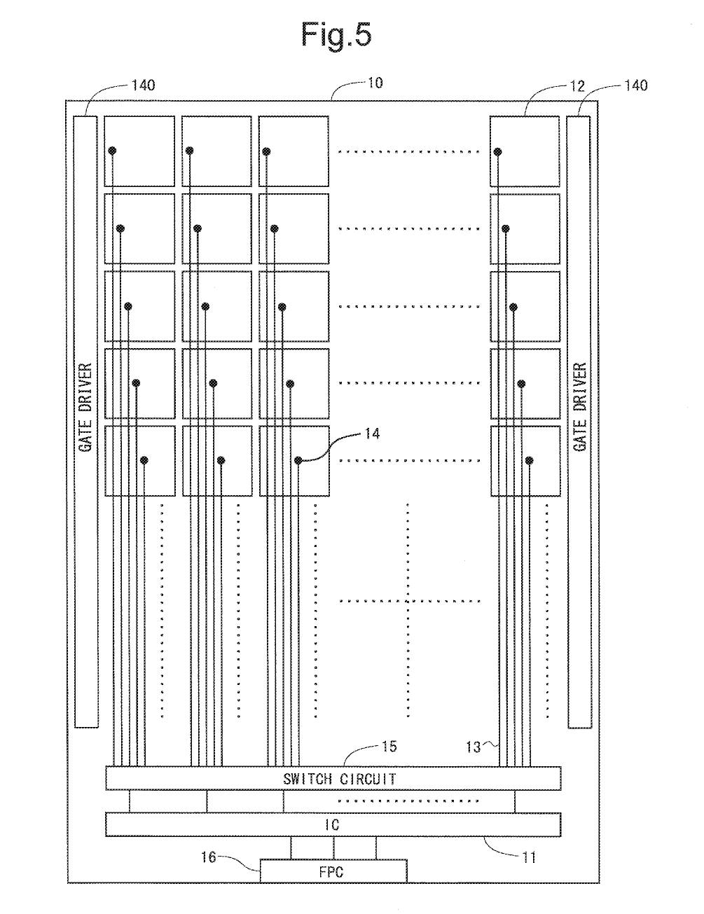

FIG. 5 is a diagram for describing a sensor pattern constituting the touch panel 115 according to the embodiment. In the present embodiment, an in-cell touch panel is adopted. The liquid crystal display device according to the present embodiment includes a liquid crystal panel formed by two glass substrates (TFT array substrate and color filter substrate) that face each other. Constituent elements for touch detection are provided on a TFT array substrate 10 among the two glass substrates. As shown in FIG. 5, as the constituent elements for touch detection, sensor electrodes (touch detection electrodes) 12, touch detection wires 13, the IC 11 described above, a switch circuit 15, and an FPC 16 are provided on the TFT array substrate 10. The IC 11 is connected to the controller 100 (the IC 18 for the touch panel and the IC 19 for display) described above through the FPC 16. Contact portions 14 for connecting the sensor electrodes 12 and the touch detection wires 13 are provided on the TFT array substrate 10. It should be noted that the gate driver 140 described above is formed on both of left and right sides of a region, out of a region on the TFT array substrate 10, where the plurality of sensor electrodes 12 are provided.

In the present embodiment, one electrode functions as the common electrode 54 and also as the sensor electrode 12. More specifically, a conventional general common electrode is divided into a matrix as shown in FIG. 5 to form a plurality (K pieces, where K is four or more) of sensor electrodes 12. For example, a conventional general common electrode is divided into 18 pieces in a lateral direction (extending direction of the gate bus line GL), and into 32 pieces in a longitudinal direction (extending direction of the source bus line SL). In this case, 576 sensor electrodes 12 are formed. Each electrode after the division functions as the common electrode 54 when a process for image display is performed, and functions as the sensor electrode 12 when a process for touch detection is performed. It should be noted that the number of division of the common electrode 54 is not particularly limited as long as the common electrode 54 is divided depending on a target resolution.

One end of the touch detection wire 13 is connected to the contact portion 14 formed at the corresponding sensor electrode 12, and the other end of the touch detection wire 13 is connected to the IC 11 through the switch circuit 15. Thereby, the drive signal SD can be supplied from the IC 11 to each sensor electrode 12, and a touch position can be identified based on the detection signal SX.

The switch circuit 15 is configured by a large number of switches for controlling connection relationships between the touch detection wires 13 and the IC 11, and electrically connects or electrically disconnects the sensor electrodes 12 by controlling a state of each switch. A segment size is switched by such electrical connection or electrical disconnection of the sensor electrodes 12. It should be noted that, although the switch circuit 15 is provided outside the IC 11 in the configuration shown in FIG. 5, a configuration where the switch circuit 15 is provided inside the IC 11 may be adopted.

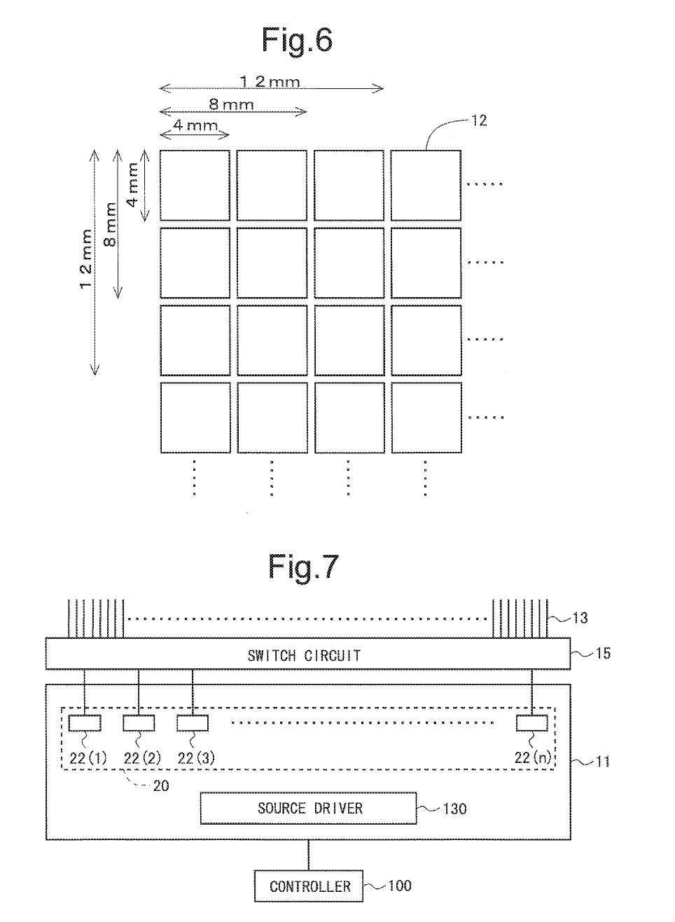

As shown in FIG. 6, one sensor electrode 12 has a horizontal size of 4 mm and a vertical size of 4 mm, for example. In this case, when each segment is made up of one sensor electrode 12, each segment has a horizontal size of 4 mm and a vertical size of 4 mm. For example, when each segment is made up of four (2×2) sensor electrodes 12, each segment has a horizontal size of 8 mm and a vertical size of 8 mm. For example, when each segment is made up of nine (3×3) sensor electrodes 12, each segment has a horizontal size of 12 mm and a vertical size of 12 mm. It should be noted that the reason why the sensor electrode 12 has a horizontal size of 4 mm and a vertical size of 4 mm is to enable accurate recognition of a person's finger.

FIG. 7 is a diagram showing a schematic configuration of the IC 11. The IC 11 includes the source driver 130, and an AFE block 20 formed by a plurality (n) of AFEs 22(1), . . . , 22(n) for processing the detection signal SX. It should be noted that “AFE” is an abbreviation of “Analog Front End”. The IC 11 is connected to the controller 100, and parts of the touch panel control unit 110 (the switching control unit 111, the position detection processing unit 113) and the display control unit 120 are included in the controller 100 (see FIG. 2).

It should be noted that, although constituent elements other than the constituent elements shown in FIG. 7 are also included in the IC 11, they are not directly relevant to the present invention, and description and illustration thereof are omitted. Furthermore, although an example where one AFE block 20 is provided is shown, two AFE blocks may be provided instead taking into account a case where characteristics of the AFE are different between one end side and the other end side in the IC 11.

As described above, the position detection processing unit 113 and the switching control unit 111 are included in the controller 100. The position detection processing unit 113 determines presence or absence of a touch to the sensor electrode 12 provided on the TFT array substrate 10 (more specifically, a segment made up of one or a plurality of sensor electrodes 12) and specifies a touch position, based on outputs from the AFEs 22(1), . . . , 22(n). The switching control unit 111 controls a state of a switch in the switch circuit 15.

In the present embodiment, a self-capacitance method is used as a position detection method. The self-capacitance method is a method of specifying a position of a recognition target object by detecting an increase in electrostatic capacitance which is caused by contact or approach of the recognition target object to the touch panel. Conventionally, in a case where a sensor pattern including a plurality of electrodes which are arranged in a matrix is adopted, a process for touch detection is performed while switching a connection destination of the AFE using a switch. For example, when nine AFEs are provided in a case where 576 sensor electrodes 12 are formed as described above, the process for touch detection is sequentially performed for each of the nine sensor electrodes 12. That is, the nine AFEs are connected to nine sensor electrodes 12 in a one-to-one correspondence in a first touch detection period. In this state, the drive signal SD is supplied to each sensor electrode 12, and presence or absence of a touch to each sensor electrode 12 is determined based on the detection signal SX which is obtained in response. Then, in a next touch detection period, the nine AFEs are connected to nine different sensor electrodes 12 in a one-to-one correspondence. In this state, the drive signal SD is supplied to each sensor electrode 12, and presence or absence of a touch to each sensor electrode 12 is determined based on the detection signal SX which is obtained in response. By repeating such a process, presence or absence of a touch is determined for all the sensor electrodes 12, and a position which is touched is specified.

As described above, a process for touch detection is performed while switching the connection destination of each AFE 22(1), . . . , 22(n). That is, each AFE 22(1), . . . , 22(n) is used in a shared manner as a circuit for processing the detection signals SX obtained from a plurality of sensor electrodes 12. By using the AFE in a shared manner, the size of the IC 11 can be reduced, and the cost is also reduced.

It should be noted that, in the present embodiment, a signal processing unit is realized by the AFE block 20, and a switching circuit unit is realized by the switch circuit 15.

### 3. Switching (Change) of Segment Size

Generally, accuracy of touch detection is more reduced as the segment size is more increased. However, sensitivity is more increased as the segment size is more increased. In this manner, with respect to changing of the segment size, there is a relationship of trade-off between sensitivity and accuracy. Depending on a use state of a user, high accuracy may not be demanded for touch detection. For example, in the case where a button size prepared by an application is large, accuracy of touch detection is not considered an important element. In view of such an aspect, the present embodiment allows switching (change) of the segment size, as described above.

A size that can be selected as the segment size is prepared in advance for each device. Here, for the sake of convenience, it is assumed that three sizes are prepared as the segment size. The three sizes are referred to as “first to third patterns”. The first pattern is a pattern where each segment is made up of one sensor electrode 12. The second pattern is a pattern where each segment is made up of four (2×2) sensor electrodes 12. The third pattern is a pattern where each segment is made up of nine (3×3) sensor electrodes 12. The segment size is switched between the three patterns as appropriate. In this manner, in the liquid crystal display device with a built-in touch sensor according to the present embodiment, the segment size may be freely switched between sizes which are set in advance.

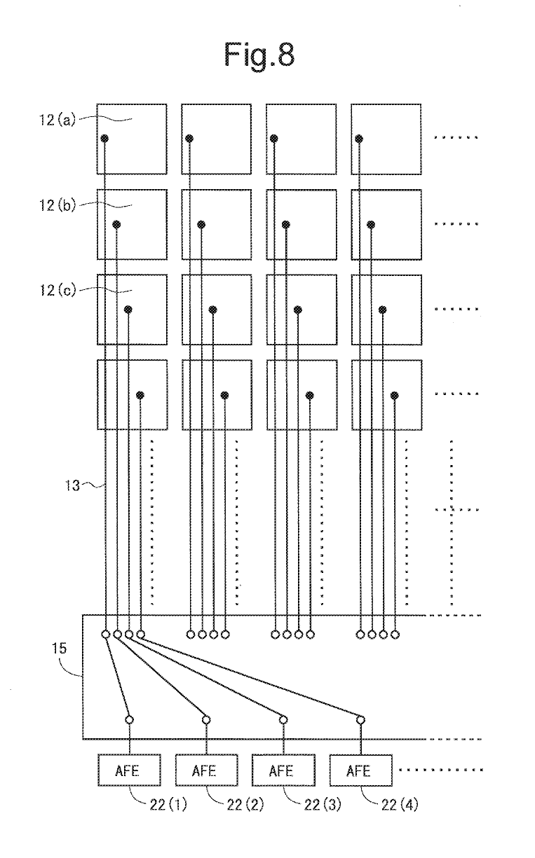

FIG. 8 is a diagram showing a connection state between the touch detection wires 13 and the AFEs 22 at a certain time point in a case in which a state of the segment is the first pattern. As shown in FIG. 8, each AFE 22 is connected to one sensor electrode 12. When a certain touch detection period is over, each AFE 22 is connected to one different sensor electrode 12.

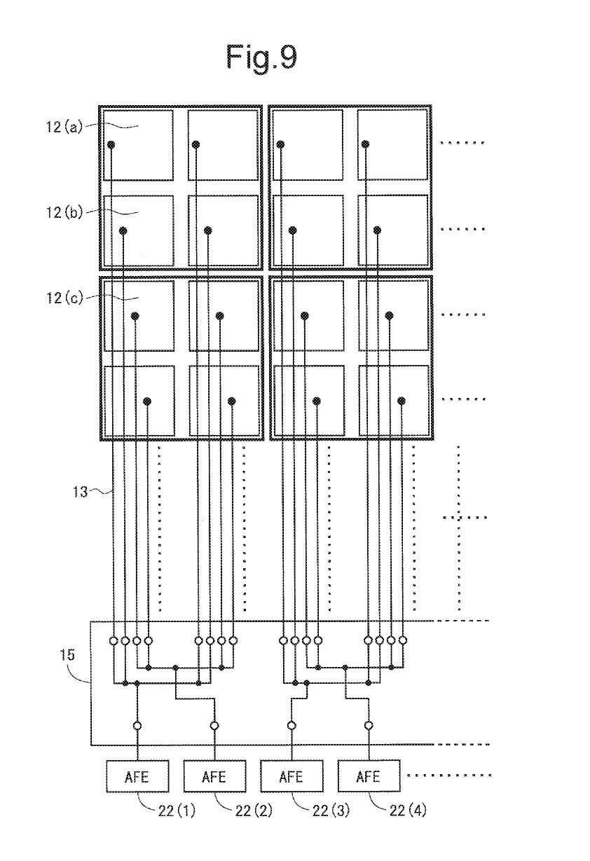

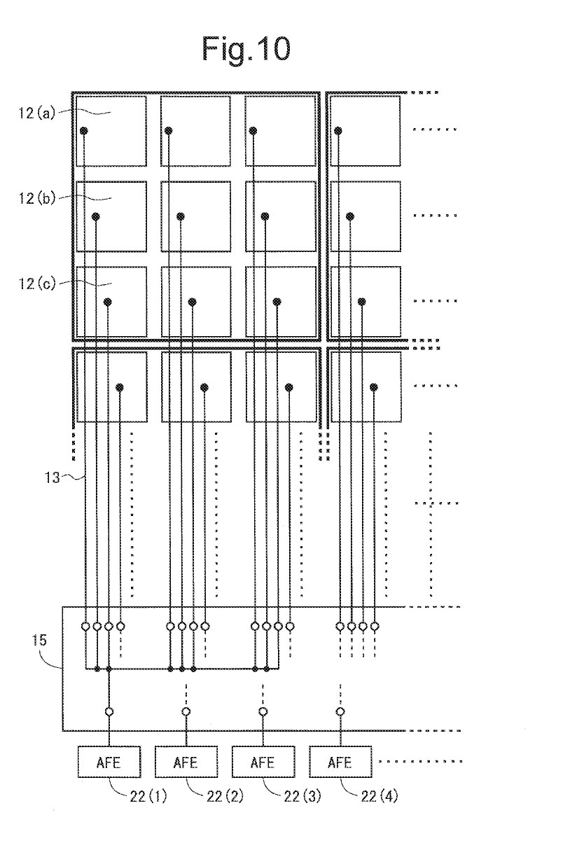

FIG. 9 is a diagram showing a connection state between the touch detection wires 13 and the AFEs 22 at a certain time point in a case in which a state of the segment is the second pattern. It should be noted that each segment is indicated by a thick frame (the same also applies to FIG. 10). As shown in FIG. 9, each AFE 22 is connected to four (2×2), sensor electrodes 12. When a certain touch detection period is over, each AFE 22 is connected to four different sensor electrodes 12.

FIG. 10 is a diagram showing a connection state between the touch detection wires 13 and the AFEs 22 at a certain time point in a case in which a state of the segment is the third pattern. As shown in FIG. 10, each AFE 22 is connected to nine (3×3), sensor electrodes 12. When a certain touch detection period is over, each AFE 22 is connected to nine different sensor electrodes 12.

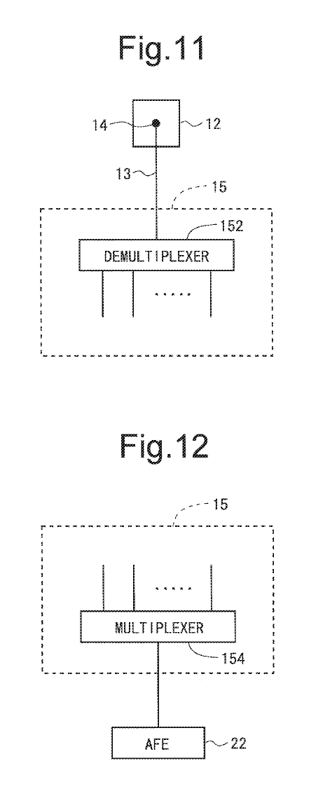

Switching between three patterns as described above is performed by switching of the connection state between the AFEs 22 and the touch detection wires 13 connected to the sensor electrodes 12 performed in the switch circuit 15. A specific configuration of the switch circuit 15 is not particularly limited, and any configuration is allowed as long as switching of the connection relationship between the K sensor electrodes 12 and the n AFEs 22(1), . . . , 22(n) may be performed so as to realize a segment size which is prepared in advance. For example, a demultiplexer or a multiplexer may be provided in the switch circuit 15 as will be described later in order to perform switching of the connection relationship between the K sensor electrodes 12 and the n AFEs 22(1), . . . , 22(n). With respect to this aspect, a sensor electrode denoted by a reference sign 12(a) in FIGS. 8 to 10 may be connected to only one AFE 22(1). A sensor electrode denoted by a reference sign 12(b) in FIGS. 8 to 10 may be connected to two AFEs 22(1), 22(2). A sensor electrode denoted by a reference sign 12(c) in FIGS. 8 to 10 may be connected to three AFEs 22(1), . . . , 22(3). In this manner, in the present embodiment, the K sensor electrodes 12 include sensor electrodes 12 that may be connected to a plurality of AFEs 22. This is achieved, for example, by providing in the switch circuit 15 a demultiplexer 152 for switching the connection destination of the sensor electrode (connection destination of the touch detection wire 13) between a plurality of the AFEs 22 (see FIG. 11). The connection destination of each AFE 22 may be switched during a period when the segment size is maintained at one size, and may also be switched by changing the segment size, as can be seen in FIGS. 8 to 10. This is achieved, for example, by providing in the switch circuit 15 a multiplexer 154 for switching the connection destination of the AFE 22 (see FIG. 12).

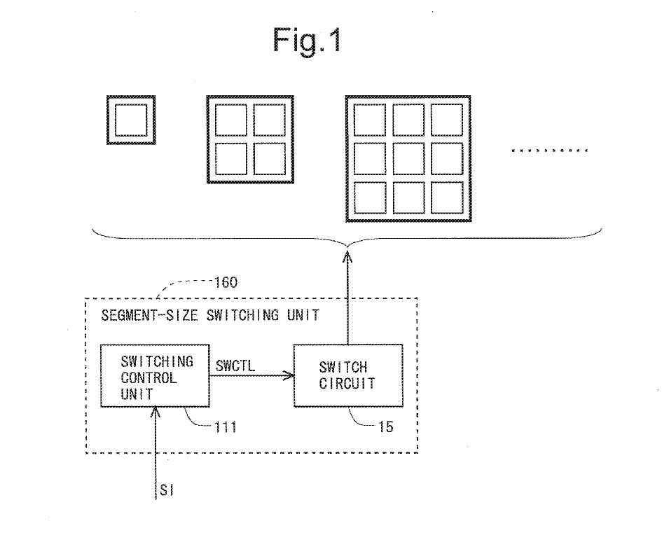

Operation of the switch circuit 15 as described above is controlled by a switching control signal SWCTL supplied from the switching control unit 111. The switching control unit 111 controls operation of the switch circuit 15 depending on a predetermined instruction signal SI. It should be noted that, in the present embodiment, a segment-size switching unit 160 configured to switch the segment size by electrically connecting or electrically disconnecting the sensor electrodes 12 is realized by the switching control unit 111 and the switch circuit 15 (see FIG. 1). With respect to the instruction signal SI, for example, when a weak signal has to be detected (when detection using a hovering function or detection of a glove is to be performed), an instruction signal SI to the effect that the segment size is to be increased (that the third pattern described above is to be selected, for example) may be supplied to the switching control unit 111, and when a signal value at a certain threshold or higher is obtained by a finger touching the touch panel 115 with respect to the detection signal SX, an instruction signal SI to the effect that the segment size is to be reduced (that the first pattern described above is to be selected, for example) may be supplied to the switching control unit 111. Furthermore, for example, the instruction signal SI may be supplied to the switching control unit 111 in such a way that the first to third patterns are selected in a time-divided manner.

As described above, the segment-size switching unit 160 realized by the switching control unit 111 and the switch circuit 15 may dynamically switch the segment size, or may switch the segment size depending on use intended by a user, or may switch the segment size between a plurality of sizes prepared in advance in a time-divided manner.

### 4. Example Application

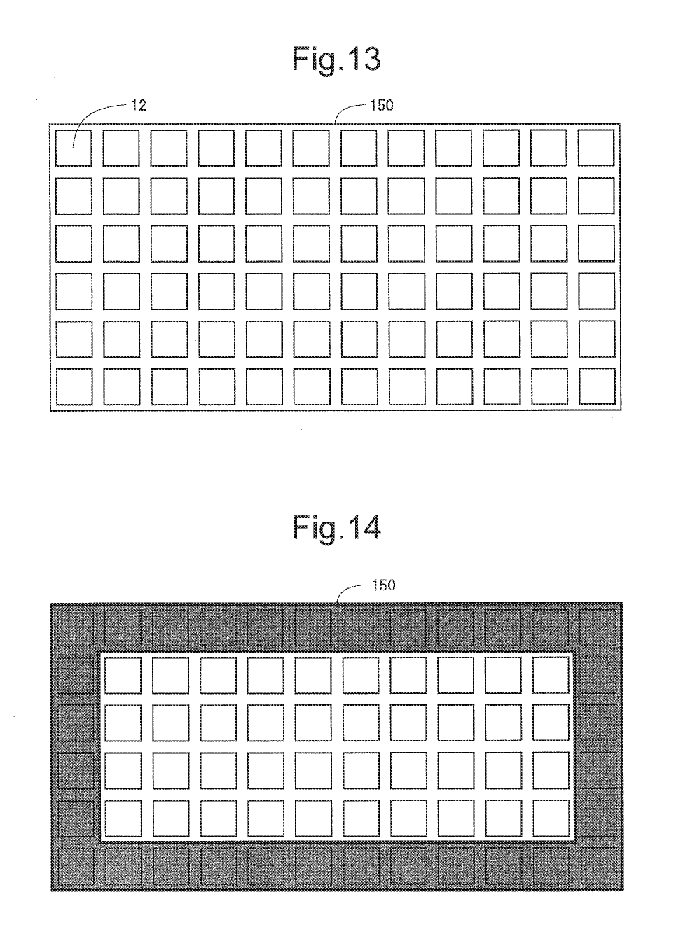

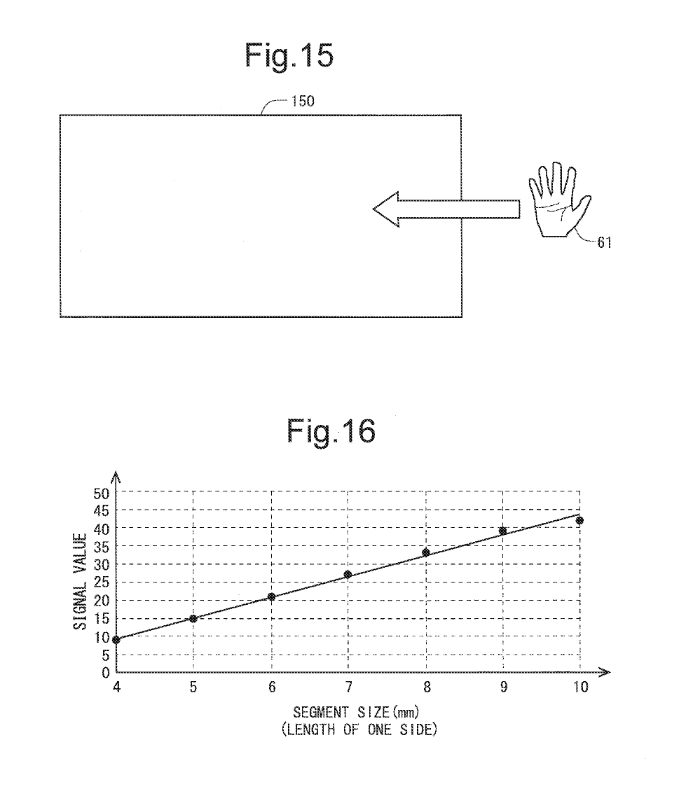

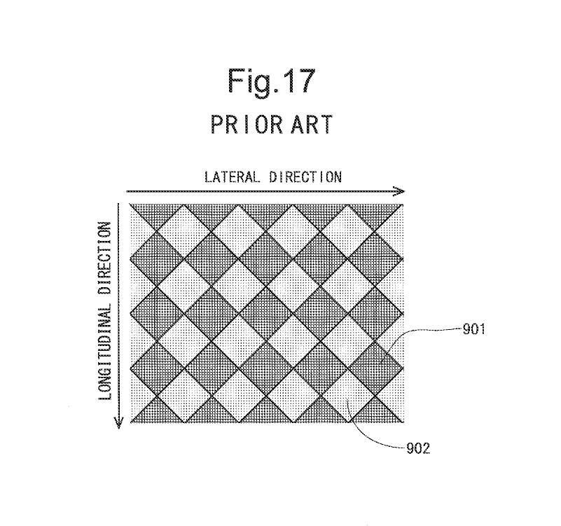

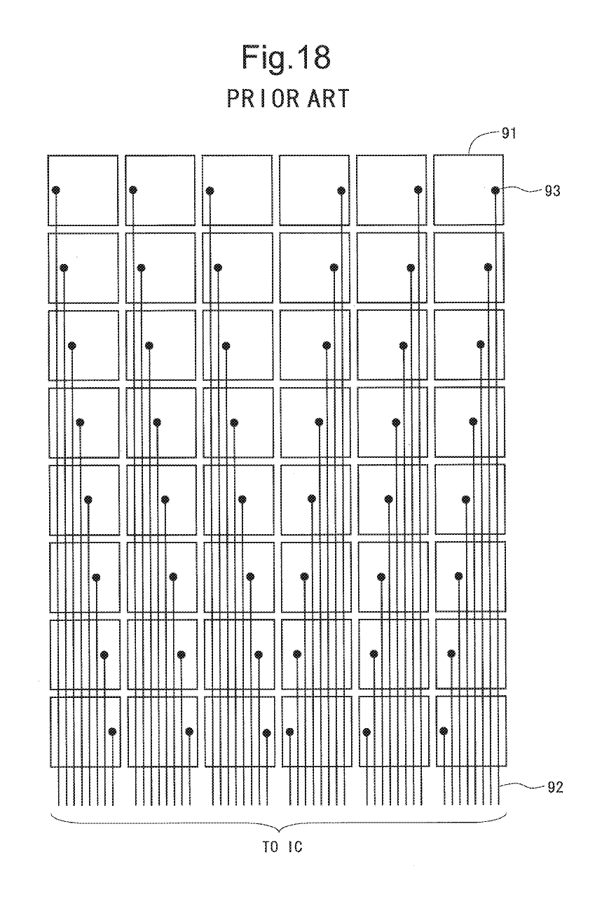

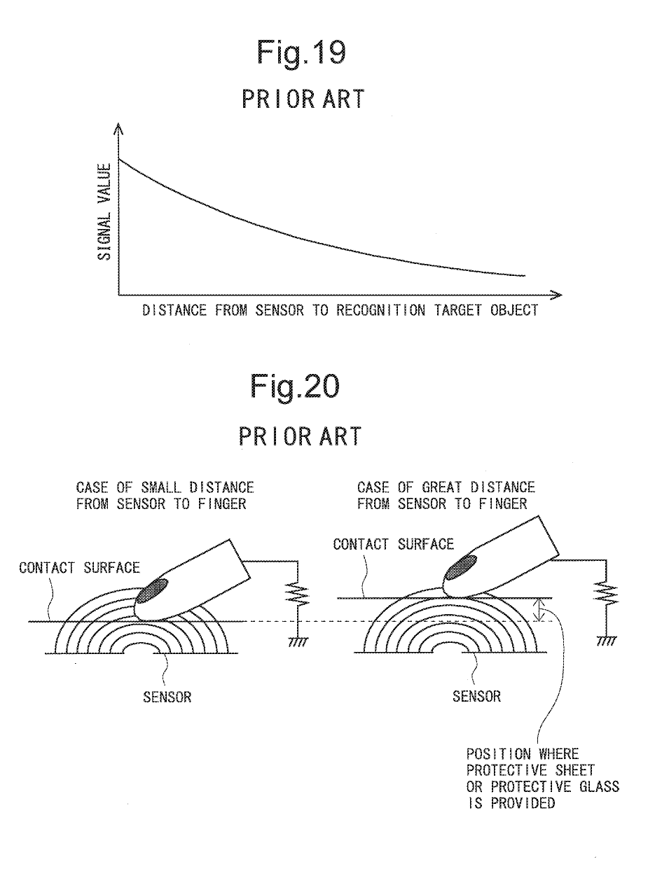

An example application of switching of the segment size will be described. Specifically, a description will be given of an example of realization of an antenna sensor function for detecting a recognition target object which is at a position (a position at a great distance from the touch panel) further away from a position where detection can be performed by a hovering function. For example, it is assumed that the sensor electrodes 12 are formed in the display unit 150 in the manner shown in FIG. 13. In such a case, one segment is configured by electrically connecting a plurality of sensor electrodes 12 which are arranged along an edge portion of the display unit 150, which is a hatched part in FIG. 14. This segment has a significantly larger area than one sensor electrode 12, and thus, this segment functions as a high-sensitivity sensor. Accordingly, for example, when a hand 61 of a person approaches the display unit 150 as shown in FIG. 15, approach of the hand 61 can be detected. With this method, an antenna sensor does not have to be provided at a peripheral edge portion of the display unit 150, and a picture-frame can be narrowed. Furthermore, low power consumption can be achieved by driving only the sensor electrodes 12 forming the segment having the antenna sensor function when an operation is not being performed.

### 5. Effects

According to the present embodiment, in the liquid crystal display device with a built-in touch sensor, the size of a segment which is a unit of processing for the detection signal SX can be freely switched between sizes which are set in advance. By the way, the relationship between the segment size and the signal value of the detection signal SX is a proportional relationship as shown in FIG. 16. The reason why such a relationship is obtained is that a value C of electrostatic capacitance is expressed by the following formula (1) according to the electrostatic capacitance method. It should be noted that ϵ0 is permittivity of vacuum (in an MKS system of units, 8.854×10⁻¹² F/m), ϵr is relative permittivity, S is an area (area of electrode), and d is a distance (distance between two conductors).

C=ϵ0·ϵr·S/d (1)

From the above, it is grasped that the larger the segment size, the higher the sensitivity of the sensor. Accordingly, a weak detection signal which was not conventionally detected can be detected by increasing the segment size as necessary. Detection using a hovering function and detection of a glove or the like may thus be performed with high accuracy. As described above, according to the present embodiment, a liquid crystal display device with a built-in touch sensor which has higher performance than the conventional one is realized.

### 6. Others

The present invention is not limited to the embodiment described above, and various modifications may be made without departing from the scope of the present invention. For example, in the embodiment described above, as the patterns of the segment size, the first pattern where each segment is made up of one sensor electrode 12, the second pattern where each segment is made up of four (2×2) sensor electrodes 12, and the third pattern where each segment is made up of nine (3×3) sensor electrodes 12 are prepared. However, the patterns are not limited thereto. A larger number of patterns may be prepared, or a pattern where the vertical size of each segment is different from the horizontal size of each segment (the vertical size is 2 and the horizontal size is 3, for example) may be prepared.

The present invention is described above in detail, but the description is illustrative in all aspects and is not restrictive. Numerous other changes and modifications are conceivable without departing from the scope of the present invention.

The present application claims priority to Japanese Patent Application No. 2017-231382 filed on Dec. 1, 2017 entitled “display device with built-in touch sensor, and drive method thereof”, the entire contents of which are incorporated herein by reference.

What is claimed is:

1. A display device, with a built-in touch sensor, including a display unit where K sensor electrodes for touch detection are arranged in a matrix, where K is an integer of four or more, and a signal processing unit configured to process detection signals obtained from the K sensor electrodes, the display device comprising:
a segment-size switching unit configured to perform electrical connection and electrical disconnection of sensor electrodes such that a size of a segment made up of one or J sensor electrodes becomes a size depending on an instruction signal, where J is an integer of 2 or more and K or less, the segment serving as a unit of processing the detection signals; and
a position detection processing unit configured to identify a touch position based on an output from the signal processing unit.

2. The display device according to claim 1, wherein the segment-size switching unit dynamically switches the size of the segment.

3. The display device according to claim 2, wherein the segment-size switching unit switches the size of the segment depending on use intended by a user.

4. The display device according to claim 1, wherein the segment-size switching unit switches the size of the segment between a plurality of sizes prepared in advance, in a time-divided manner.

5. The display device according to claim 1, wherein
the signal processing unit includes a plurality of analog front ends, and
the segment-size switching unit includes
a switching circuit unit configured to switch a connection relationship between the K sensor electrodes and the plurality of analog front ends, and
a switching control unit configured to control operation of the switching circuit unit depending on the instruction signal.

6. The display device according to claim 1, wherein a segment electrically connecting a plurality of sensor electrodes that are arranged along an edge portion of the display unit is provided.

7. The display device according to claim 1, wherein
the display unit includes a pixel electrode for applying a voltage depending on a display image, and a common electrode provided facing the pixel electrode, and
the K sensor electrodes are used in a shared manner as the common electrode.

8. A drive method of a display device, with a built-in touch sensor, including a display unit where K sensor electrodes for touch detection are arranged in a matrix, where K is an integer of four or more, and a signal processing unit configured to process detection signals obtained from the K sensor electrodes, the drive method comprising:
a segment-size switching step of performing electrical connection and electrical disconnection of sensor electrodes such that a size of a segment made up of one or J sensor electrodes becomes a size depending on an instruction signal, where J is an integer of 2 or more and K or less, the segment serving as a unit of processing the detection signals; and
a position detection step of identifying a touch position based on an output from the signal processing unit.
